(19) United States
(12) Patent Application Publication
(10) Pub. No.: US 2007/0279363 A1
(43) Pub. Date: Dec. 6, 2007

(54) DISPLAY APPARATUS, DEVICE FOR DRIVING THE SAME AND METHOD OF DRIVING THE SAME

(76) Inventors: Ho-Suk MAENG, Seoul (KR); Kook-Chul Moon, Yongin-si (KR); Pil-Mo Choi, Seoul (KR); Shul-Ho Kim, Yongin-si (KR); Sang-Hoon Lee, Seoul (KR); Kyung-Hoon Kim, Uiwang-si (KR); Keun-Woo Park, Seoul (KR)

Correspondence Address: Frank Chau, Esq.;F. CHAU & ASSOCIATES, LLC, 130 Woodbury Road, Woodbury, NY, 11797, US

(21) Appl. No.: 11/747,306

(22) Filed: May 11, 2007

(30) Foreign Application Priority Data
Jun. 2, 2006 (KR) 2006-49670

(51) Int. Cl. G09G 3/36

(52) U.S. Cl. 345/100

(57) ABSTRACT

A display apparatus includes a display panel, a driving part, a gate driving part and a gate selecting part. The display panel has source lines and gate lines intersecting the source lines. The driving part converts original data signals received through an interlaced scan method into analog-type data voltages and outputs the data voltages to the source lines. The gate driving part sequentially outputs gate signals. The gate selecting part selectively outputs the gate signals to odd-numbered gate lines and even-numbered gate lines corresponding to the data voltages output to the source lines.

### CROSS-REFERENCE TO RELATED PATENT APPLICATIONS

This application claims priority to Korean Patent Application No. 2006-49670, filed on Jun. 2, 2006 in the Korean Intellectual Property Office (KIPO), the disclosure of which is incorporated by reference herein.

### BACKGROUND OF THE INVENTION

1. Technical Field

The present disclosure relates to a display apparatus, a device for driving the display apparatus, and a method of driving the display apparatus. More particularly, the present disclosure relates to a display apparatus using an interlaced scan method for showing images, and a device for driving the display apparatus and a method of driving the display apparatus.

2. Discussion of the Related Art

According to a conventional method of displaying images, images are displayed on a screen by using a scanning line that scans the screen from left to right and from top to bottom. For example, after one line has been displayed, the scanning line advances to display the next line.

Conventional scan methods may include a progressive scan method and an interlaced scan method. According to the progressive scan method, the lines of each frame are sequentially scanned. According to the interlaced scan method, the lines of each frame are divided into an even field which includes the even-numbered lines and an odd field which includes the odd-numbered lines. The odd-numbered lines are scanned first, and the even-numbered lines are scanned second.

A liquid crystal display (LCD) apparatus typically employs the progressive scan method which activates gate lines sequentially. However, in a television, image signals are transferred using the interlaced scan method. An LCD apparatus which employs the progressive scan method requires a frame memory to support the display of television image signals transferred by the interlaced scan method. The LCD apparatus stores image signals transferred by the interlaced scan method in the frame memory in frames, and displays images in the progressive scan method by outputting the frames stored in the frame memory line by line.

An LCD apparatus which displays images transferred using the interlaced scan method requires complex hardware and software. Therefore, a need exists for a simpler LCD apparatus, which can display images transferred using the interlaced method.

### SUMMARY OF THE INVENTION

In an exemplary embodiment of the present invention, a display apparatus includes a display panel, a driving part, a gate driving part and a gate selecting part. The display panel has source lines and gate lines intersecting the source lines. The driving part converts original data signals received through an interlaced scan method into analog-type data voltages and outputs the data voltages to the source lines. The gate driving part sequentially outputs gate signals. The gate selecting part selectively outputs the gate signals to odd-numbered gate lines and even-numbered gate lines corresponding to the data voltage output to the source lines.

In exemplary embodiment of the present invention, a device for driving the display apparatus includes a red-green-blue (RGB) converting part, a source driving part, a gate driving part and a gate selecting part. The display apparatus has a display panel including a display region having source lines and gate lines intersecting with the source lines and a peripheral region surrounding the display region. The RGB converting part converts original data signals received through an interlaced scan method into RGB signals. The source driving part converts the RGB signals into analog-type data voltages and outputs the data voltages to the source lines. The gate driving part sequentially outputs gate signals. The gate selecting part selectively outputs the gate signals to odd-numbered gate lines and even-numbered gate lines corresponding to the data voltages applied to the source lines.

In an exemplary embodiment of the present invention provides a method of driving a display apparatus. The display apparatus includes a panel having source lines and gate lines intersecting with the source lines. The method includes the steps of converting original data signals transferred in an interlaced scan method into analog-type data voltages to output the data voltages to the source lines, and selectively outputting the gate signals to odd-numbered gate lines and even-numbered gate lines corresponding to the data voltages applied to the source lines.

### BRIEF DESCRIPTION OF THE DRAWINGS

The above and other features of the present invention will become more readily apparent by describing in detail exemplary embodiments thereof with reference to the accompanying drawings, in which:

FIG. 1 is a plan view illustrating a display apparatus in accordance with an exemplary embodiment of the present invention;

FIG. 2 is a block diagram illustrating an embodiment of a driving part in FIG. 1;

FIG. 3 is a block diagram illustrating an embodiment of a source driving part in FIG. 2;

FIG. 4 is a block diagram illustrating an embodiment of a gate driving part and a gate selecting part in FIG. 1;

FIG. 5 is a timing diagram of an input/output signal, which is used to explain a method of driving the display apparatus in FIG. 1, according to an exemplary embodiment of the present invention; and

FIG. 6 is a conceptual view illustrating a process of displaying one frame in accordance with an exemplary embodiment of the present invention.

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein.

It will be understood that when an element or layer is referred to as being “on,” “connected to” or “coupled to” another element or layer, it can be directly on, connected or coupled to the other element or layer or intervening elements or layers may be present.

Hereinafter, exemplary embodiments of the present invention will be explained in more detail with reference to the accompanying drawings.

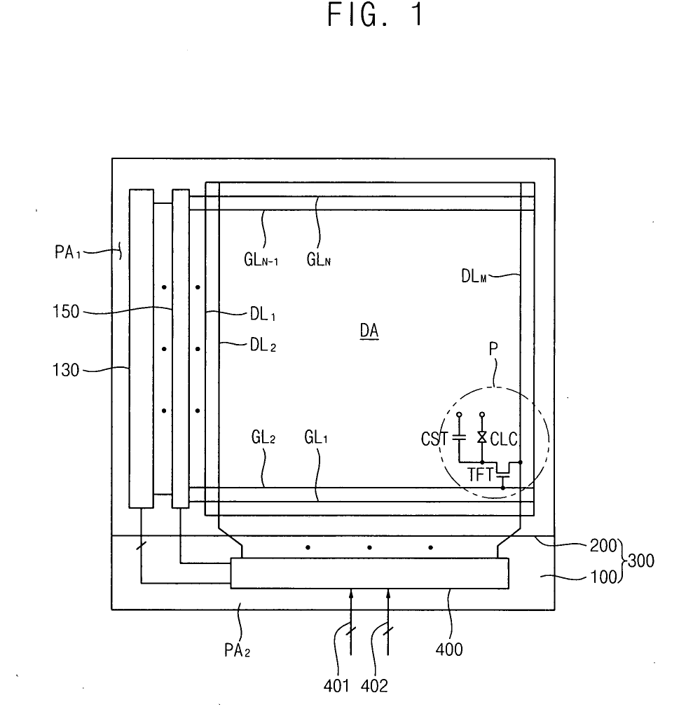

FIG. 1 is a plan view illustrating a display apparatus in accordance with an exemplary embodiment of the present invention.

Referring to FIG. 1, the display apparatus includes a display panel 300, a gate driving part 130, a gate selecting part 150 and a driving part 400.

The display panel 300 includes an array substrate 100, an opposite substrate 200 and a liquid crystal layer (not shown) interposed between the array substrate 100 and the opposite substrate 200. The array substrate 100 includes a display area DA and a peripheral area PA. Images are displayed in the display area DA. The peripheral area PA surrounds the display area DA. The display area DA includes source lines DL₁, DL₂, . . . , DL_{M} and gate lines GL₁, GL₂, . . . , GL_{N}, wherein M and N are natural numbers. The source lines DL₁, DL₂, . . . , DL_{M} and the gate lines GL₁, GL₂, . . . , GL_{N} intersect each other, and define M×N number of pixel parts. Thus, the resolution of the display panel 300 is M×N. Each pixel part includes a thin-film transistor (TFT), a storage capacitor CST and a pixel electrode (not shown). The pixel electrode is a first electrode of a liquid crystal capacitor CLC.

The opposite substrate 200 is combined with the array substrate 100 and the liquid crystal layer is disposed between the array substrate 100 and the opposite substrate 200. The opposite substrate 200 includes a common electrode (not shown). The common electrode faces the pixel electrode and is a second electrode of the liquid crystal capacitor.

The gate driving part 130 is disposed in a first peripheral area PA1 of the array substrate 100 and sequentially outputs N/2 number of gate signals. For example, the gate driving part 130 may be mounted to the first peripheral area PA1 or may be integrated into the first peripheral area PA1.

According to a control signal of the driving part 400, the gate selecting part 150 selectively outputs the N/2 number of gate signals to odd-numbered gate lines GL_{2K-1} or even-numbered gate signals GL_{2K}, wherein K is a natural number. The gate selecting part 150 may be integrated into the first peripheral area PA1. Alternatively, when the gate driving part 130 is formed as a gate driving chips the gate driving chip may include the gate selecting part 150.

The driving part 400 receives original control signals 401 and original data signals 402 from an external device. The driving part 400 transforms the original data signals 402 to data signals corresponding to the display panel 300 and outputs the data signals to the source lines DL₁, DL₂, . . . , DL_{M}. The original data signals include color signals of a luminance-bandwidth-chrominance (YUV) signal. A frame of the original data signals has a resolution of I×J, wherein I and J are natural numbers. The frame is divided into an odd field and an even field. The original data signals are received via the interlaced scan method. The YUV signal may be received as an 8-bit signal.

For example, assuming the original data signals are standard definition (SD) NTSC-type signals, the color signals are YUV signals, the resolution is 720×480 and the field frequency is 60 Hz. The transferring method is an interlaced scan method and the original data signals may be transferred with an 8-bit data bus and a frame frequency of 30 Hz.

The gate driving part 130 receives control signals from the driving part 400 and sequentially outputs N/2 number of gate signals. The driving part 400 controls the gate selecting part 150 to output the gate signals. The gate signals are output to odd-numbered data lines GL_{2K-1} or even-numbered data lines GL_{2K} corresponding to data signals from the source lines DL₁, DL₂, . . . , DL_{M}.

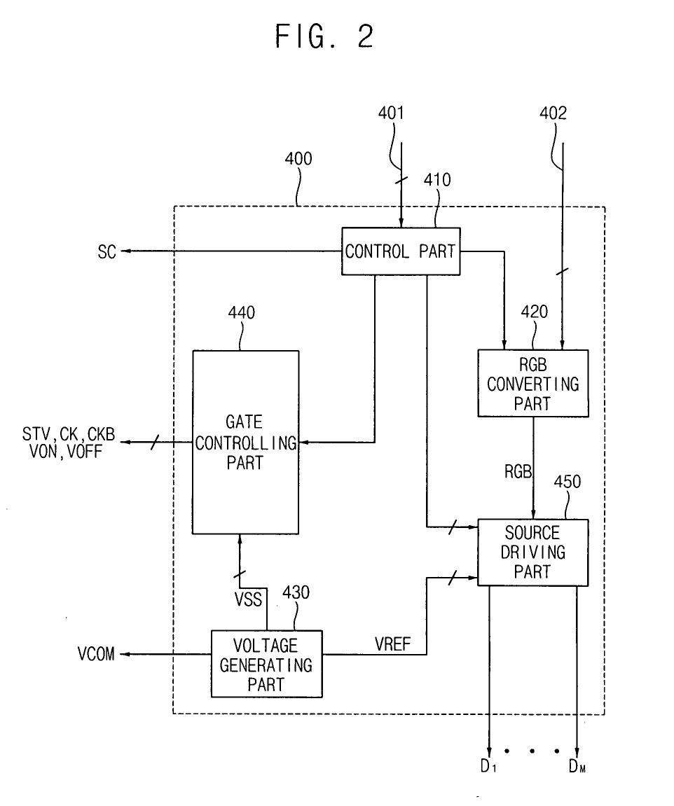

FIG. 2 is a block diagram illustrating an embodiment of the driving part 400 illustrated in FIG. 1.

Referring to FIGS. 1 and 2, the driving part 400 includes a control part 410, an RGB converting part 420, a voltage generating part 430, a gate controlling part 440 and a source driving part 450.

The control part 410 controls the overall driving of the driving part 400 based on the received original control signals 401.

The RGB converting part 420 receives original data signals 402 from an external device, and converts the original data signals 402 into RGB signals. The original data signals are transferred by the interlaced scan method. The original data signals are YUV signals. The Y signal stands for the luminance component and the U and V signals are the chrominance components. Weighted values of the original R, G and B signals are added together to produce a single Y signal, representing the overall brightness, or luminance, of a particular spot. The U signal is then created by subtracting the Y signal from the blue signal of the original RGB signals, and then by scaling the result using a first factor. The V signal is created by subtracting the Y signal from the red, and then scaling the result using a second factor. The scaling may be accomplished by using analog circuitry. The relationship between the YUV signals and the RGB signals can be illustrated by the following exemplary Equation 1.

Y=0.299R+0.587G+0.114B

U=0.492(B−Y)=0.147R−0.289G+0.4368

V=0.877(R−Y)=0.615R−0.515G−0.100B Equation 1

The RGB converting part 420 converts the original data signals, i.e., YUV signals, into RGB signals. When the original data signals are RGB signals, the RGB converting part 420 may skip the conversion of the original data signals, or the RGB converting part 420 may be removed.

The voltage generating part 430 generates driving voltages by using an external voltage. The driving voltages correspond to gate-on/off voltages VON and VOFF, a reference gamma voltage VREF and a common voltage VCOM. The gate-on/off voltages are applied to the gate controlling part 440. The reference gamma voltage VREF is applied to the source driving part 450. The common voltage VCOM is applied to a liquid crystal capacitor CLC and a storage capacitor CST of the display panel.

The gate controlling part 440 outputs gate signals provided from the control part 410 and the gate-on/off voltages VON and VOFF to the gate driving part 130. The gate controlling signals include vertical start signals STV, a first clock signal CK and a second clock signal CKB.

According to a control signal of the control part 410, the source driving part 450 converts RGB signals provided from the ROB converting part 420 to analog-type data voltages, by using the reference gamma voltage VREF. The source driving part 450 outputs the converted analog-type data voltages D₁, D₂, . . . , D_{M} to the source lines DL₁, DL₂, . . . , DL_{M}, respectively.

The driving part 400 may further include line memory (not shown). When a line memory is included, the received original data signals 402 may be stored as horizontal lines in the line memory and individual horizontal lines may be selected according to control signals of the control part 410. Then, the received original data signals 402 may be converted into RGB signals using substantially the same data handling process as in the RGB converting part 420.

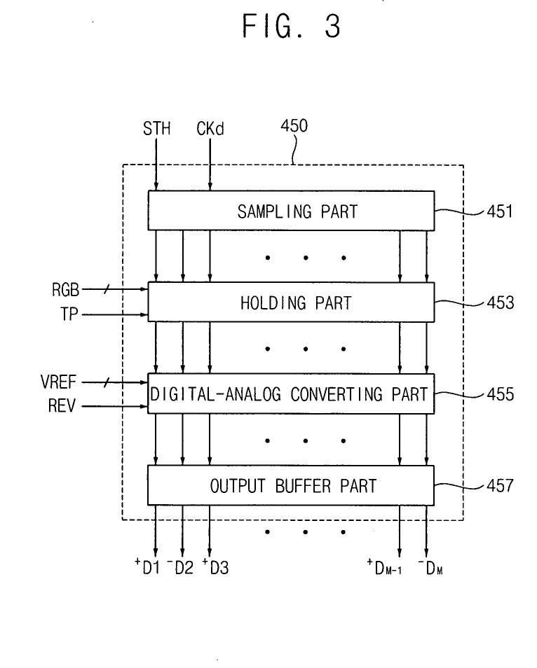

FIG. 3 is a block diagram illustrating an embodiment of the source driving part in FIG. 2.

Referring to FIGS. 1 to 3, the source driving part 450 includes a sampling part 451, a holding part 453, a digital-analog converting part 455 and an output buffer part 457.

The sampling part 451 shifts horizontal start signals, and outputs the shifted horizontal start signals as sampling signals in response to data clock signals CKd from the control part 410. The number of the sampling signals corresponds to a horizontal interval 1H.

The holding part 453 sequentially samples RGB signals provided from the RGB converting part 420, and latches the sampled RGB signals in response to the sampling signals. The holding part 453 outputs the latched RGB signals, which correspond to the horizontal interval 1H, to the digital-analog converting part 455 in response to load signals TP from the control part 410.

The digital-analog converting part 455 converts the RGB signals into analog-type data voltages by using the reference gamma voltage VREF The digital-analog converting part 455 reverses the polarity of adjacent data voltages with respect to a reference voltage based on reverse signals REV provided from the control part 410. Thus, the digital-analog converting part 455 outputs column-reversed data voltages to the output buffer part 457.

The output buffer part 457 buffers the data voltages to output the buffered data voltages to the source lines +DL₁, . . . , −DL_{M}.

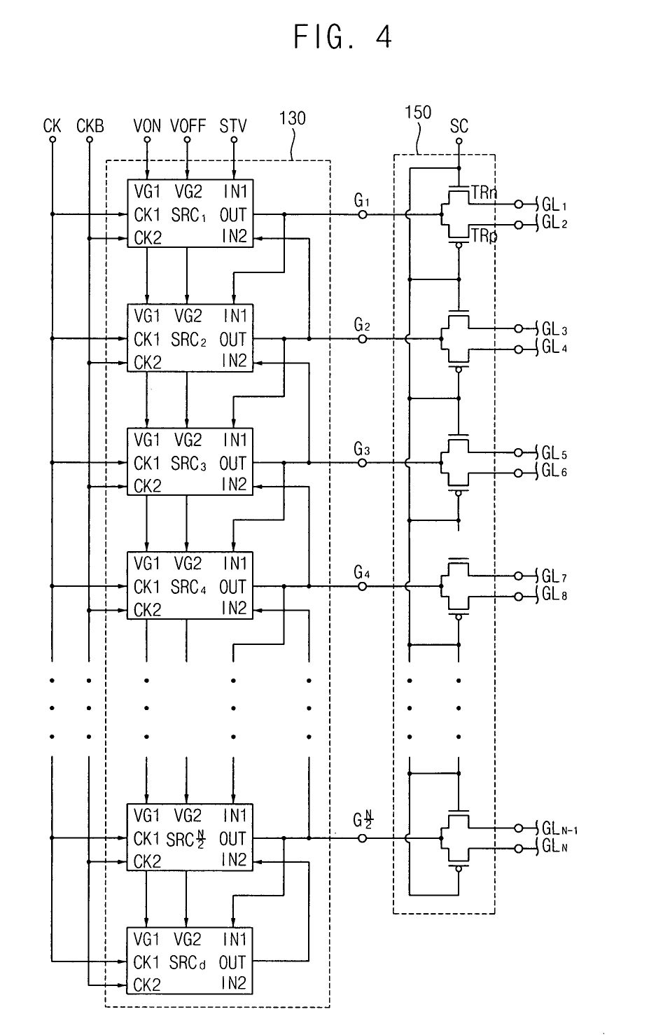

FIG. 4 is a block diagram illustrating an embodiment of the gate driving part and the gate selecting part in FIG. 1.

Referring to FIGS. 1 and 4, the gate driving part 130 sequentially outputs N/2 number of gate signals G₁, . . . , G_{N/2}. The gate driving part 130 includes N/2 number of stages SRC₁, . . . , SRC_{N/2} and one dummy stage SRC_{d}. The plurality of stages SRC₁, . . . , SRC_{N/2} is cascade-connected.

Each of the stages SRC₁, . . . , SRC_{N/2} includes a first input terminal IN1, an output terminal OUT, a second input terminal IN2, a first clock terminal CK1, a second clock terminal CK2, a first voltage terminal VG1 and a second voltage terminal VG2. A first input terminal IN1 of a first stage SRC1 receives a vertical start signal STV from the gate controlling part 440. The stages SRC₂, . . . , SRC_{d} respectively receive output signals from previous stages SRC₁, . . . , SRC_{d}, through the first input terminal IN1. The stages SRC₁, . . . , SRC_{N/2} respectively receive output signals of the remaining stages SRC₂, . . . , SRC_{d} through the second input terminal IN2. An output terminal OUT of each stage is electrically connected with an input terminal of the gate selecting part 150.

The first and second clock terminals CK1 and CK2 of the plurality of stages SRC1, . . . , SRC_{N/2} receive first and second clock signals CK and CKB. The phases of the first clock signal CK and the second clock signal CKB are opposite to each other. Odd stages output gate signals in response to the first clock signal CK applied to a first clock terminal CK1 and even stages output gate signals in response to a second clock signal CKB applied to the second clock terminal CK2.

Gate on/off voltages VON and VOFF are applied to the first and second voltage terminals VG1 and VG2 of the plurality of stages SRC1, . . . , SRC_{N/2}.

The gate selecting part 150 includes a gate controlling terminal, an input terminal and an output terminal. The gate controlling terminal receives a selecting control signal SC from the gate control part 410. The input terminal of the gate selecting part 150 is electrically connected to the output terminal OUT of the plurality of stages SRC₁, . . . , SRC_{N/2}. The output terminal of the gate selecting part 150 is electrically connected with the gate lines GL₁, . . . , GL_{N}. The gate selecting part 150 includes a first transistor TRn electrically connected with odd-numbered gate lines GL_{2K-1} and a second transistor TRp electrically connected with even-numbered gate lines GL_{2K}.

The first transistor TRn includes a gate electrode receiving the selecting control signal SC, a source electrode electrically connected with an output terminal OUT of the stage and a drain electrode electrically connected with the odd-numbered gate lines GL_{2K-1}. The second transistor TRp includes a gate electrode receiving the selecting control signal SC, a source electrode electrically connected with an output terminal OUT of the stage and a drain electrode electrically connected with the even-numbered gate lines GL_{2K}. The first transistor TRn and the second transistor TRp are driven in response to the selecting control signal SC.

For example, when the selecting control signal SC is a high pulse “1”, the first transistor TRn is turned on and outputs the gate signal to the odd-numbered gate lines GL_{2K-1}, and the second transistor TRp is turned off. As a result, the odd-numbered gate lines GL_{2K-1} receives gate signals to be activated.

Alternatively, when the selecting control signal SC is low pulse “0” the second transistor TRp is turned on and outputs the gate signal to the even-numbered gate lines GL_{2K}, and the first transistor TRp is turned off. As a result, the even-numbered gate lines GL_{2K} receive gate signals to be activated.

The gate driving part 130 and the gate selecting part 150 divide the gate lines GL1, . . . , GL_{N} into odd-numbered gate lines GL_{2K-1} and even-numbered gate lines GL_{2K}, and drive the divided gate lines by the interlaced scan method in response to the selecting control signal SC.

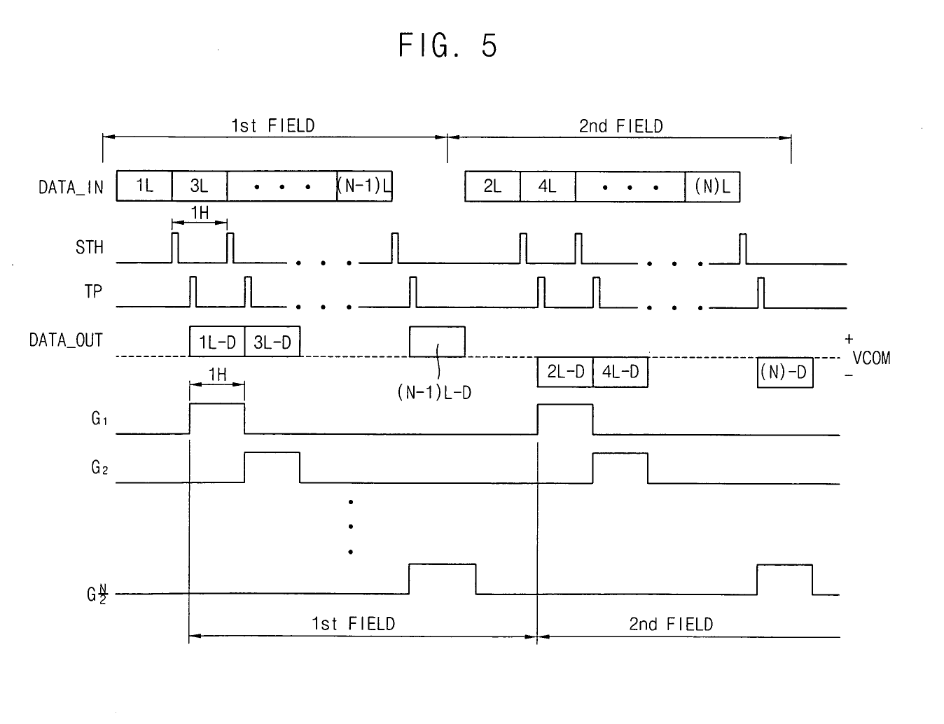

FIG. 5 is a timing diagram of an input/output signal which is used to explain a method of driving the display apparatus in FIG. 1, according to an exemplary embodiment of the present invention.

Referring to FIGS. 1 and 5, a driving part 400 receives original data signals 402 and original control signals 401 from an external device. The original control signals 401 are applied to the control part 410. The control part 410 generates control signals controlling the display apparatus, based on the original control signals 401.

The original data signals 402 are applied by an interlaced scan method into a first field and a second field of one frame (DATA_IN).

Original data signals 1L, 3L, . . . , (N−1)L of odd-numbered horizontal lines are applied to the first field. For example, the original data signal 1L of a first horizontal line is applied to the RGB converting part 420 and converted into an RGB signal, and then output to the source driving part 450. The source driving part 450 outputs an analog-type data voltage 1L-D to the source lines DL1, . . . , DLm based on the RGB signals and control signals STH, TP, REV, etc.

The sampling part 451 outputs sampling signals to the holding part 453 based on a horizontal start signal and a data clock signal CKd. The holding part 453 sequentially samples RGB signals from the RGB converting part 420, then latches the sampled RGB signals in response to the sampling signals. The holding part 453 outputs the RGB signals, which correspond to the latched horizontal interval 1H, to the digital-analog converting part 455 in response to load signals TP provided from the control part 410. The digital-analog converting part 455 converts the RGB signals into an analog-type data voltage 1L-D by using the reference gamma voltage VREF, and then outputs the analog-type data voltage 1L-D (DATA_OUT).

According to this method, data voltages 1L-D, 3L-D, . . . , (N−1)L-D of the odd-numbered horizontal at lines are output to the source lines DL₁, . . . , DL_{M} during the first field.

During the first field, the gate driving part 130 sequentially outputs the N/2 number of gate signals G1, . . . , G_{N/2} based on a control signal of the gate controlling part 440. The gate selecting part 150 sequentially outputs the N/2 number of gate signals G1, . . . , G_{N/2} to the odd-numbered gate lines GL1, . . . , GL_{N-1} based on the selecting control signal SC.

Thus, during the first field, pixel parts of odd-numbered horizontal lines are activated and a first field screen in the display panel is displayed.

Original data signals 2L, 4L, . . . , (N)L of even-numbered horizontal lines are applied to the second field. The original data signals 2L 4L, . . . , (N)L of even-numbered horizontal lines and the original data signals 1L, 3L, . . . , (N−1)L of odd-numbered horizontal lines are handled in substantially the same way. The handled data voltages 2L-D, 4L-D, . . . , (N)L-D are applied to the source lines DL1, . . . , DLm. A polarity of the even-numbered data voltages 2L-D, 4L-D, . . . , (N)L-D and a polarity of the odd-numbered data voltages 1L-D, 3L-D, . . . , (N−1)L-D are opposite with respect to a reference voltage.

The gate selecting part 150 sequentially outputs the N/2 number of gate signals G1, . . . , G_{N/2} to the even-numbered gate lines GL2, GL4 . . . GL_{N} based on the selecting control signal SC.

Thus, during the second field, pixel parts of even-numbered horizontal lines are activated and a second field screen in the display panel 300 is displayed.

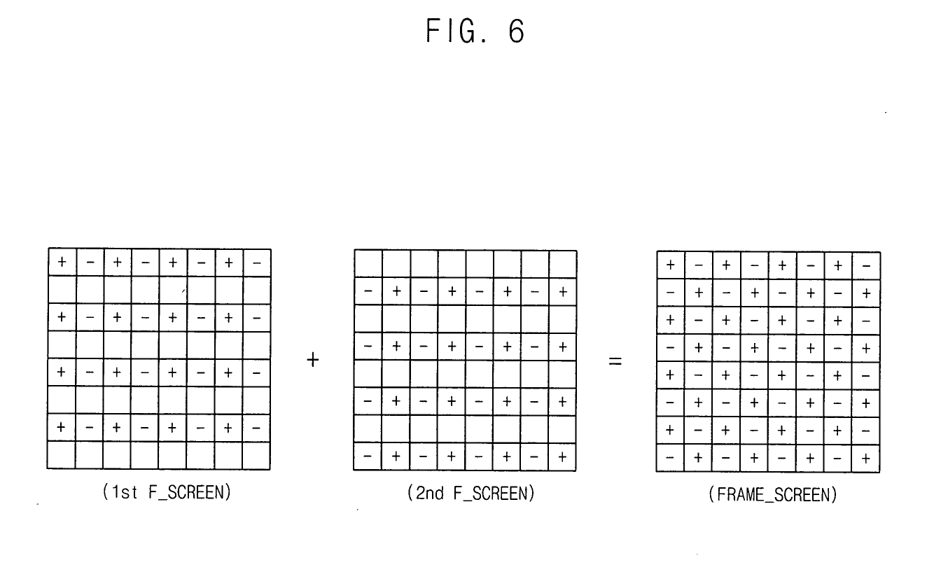

FIG. 6 is a conceptual view illustrating a process of displaying one frame in accordance with an exemplary embodiment of the present invention.

Hereinafter, an example of an NTSC process in a display apparatus according to an exemplary embodiment of the present invention having a VGA level will be described. The term VGA is used to refer to a resolution of 640×480. The NTSC process interlaces 60 fields per second, which means that 30 frames are transferred per second. The resolution of the frame is 720×480.

Referring to FIGS. 5 and 6, during the first field, the display apparatus charges pixel parts of odd-numbered horizontal lines with data voltages, and displays a first field screen 1^{st} F_SCREEN. Data voltages having the same polarity (+ or −) are charged in pixel parts along a column direction, so that a charging rate may be enhanced. Data voltages having a first polarity (+) and data voltages having a second polarity (−) opposite to the first polarity with respect to a reference voltage are alternately charged in pixel parts along a row direction.

The display apparatus charges pixel parts of even-numbered horizontal lines with data voltages and displays a second field screen 2^{nd} F_SCREEN during the second field. Data voltages having the same polarity (+ or −) are charged in pixel parts along the column direction, so that a charging rate may be enhanced. Data voltages having the first polarity (+) and data voltages having the second polarity (−) are alternately charged in pixel parts along the row direction.

The second field screen is driven using a line inversion method in comparison with the first field screen.

One frame screen FRAME_SCREEN includes the first field screen 1^{st} F_SCREEN and the second field screen 2^{nd} F₁₃ SCREEN in the display apparatus. The frame screen FRAME_SCREEN is driven using a dot inversion method by the line inversion method of the first and second field screens 1^{st} F_SCREEN and 2^{nd} F_SCREEN.

The display apparatus has a frame frequency of 30 Hz, so that power consumption is reduced in comparison with a conventional display apparatus having a frame frequency of 60 Hz. Additionally, flicker effects may be minimized due to the dot inversion method.

At least one embodiment of a display apparatus of the present invention does not need frame memory to store data signals by frames, allowing for a smaller data bus. For example, YUV signals may be transferred by an 8-bit data bus, and thus the data bus bits may be minimized in comparison with RGB signals having a 24-bit data bus.

Further, through a reverse method of the first and second fields, dot inversion effects are generated, and the inversion effect may be enhanced. In addition, at least one embodiment of a display apparatus of the present invention has a frame rate of 30 frames per second which may reduce power consumption in comparison with a conventional display apparatus having a frame rate of 60 frames per second.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel having source lines and gate lines intersecting the source lines,
a driving part converting original data signals provided in an interlaced scan method into analog-type data voltages, and outputting the data voltages to the source lines;
a gate driving part sequentially outputting gate signals; and
a gate selecting part selectively outputting the gate signals to odd-numbered gate lines and even-numbered gate lines corresponding to the data voltages output to the source lines.

2. The display apparatus of claim 1, wherein the driving part comprises a red-green-blue (RGB) converting part converting the original data signals into RGB signals.

3. The display apparatus of claim 2, wherein the driving part comprises a source driving part converting the RGB signals into the data voltages, and outputting the data voltages.

4. The display apparatus of claim 3, wherein the source driving part outputs the data voltages having an opposite polarity with respect to a reference voltage to the adjacent source lines, respectively.

5. The display apparatus of claim 4, wherein, the source driving part converts the original data signals of first and second fields into the data voltages having the opposite polarity with respect to the reference voltage, respectively, and outputs the data voltages.

6. A device for driving a display apparatus having a display panel including a display region having source lines and gate lines intersecting with the source lines and a peripheral region surrounding the display regions the driving device comprising:
an RGB converting part converting original data signals received through an interlaced scan method into RGB signals;
a source driving part converting the RGB signals into analog-type data voltages and outputting the data voltages to the source lines;
a gate driving part sequentially outputting gate signals; and
a gate selecting part selectively outputting the gate signals to the odd-numbered gate lines and the even-numbered gate lines in accordance with the data voltages applied to the source lines.

7. The device of claim 6, wherein the gate selecting part is integrated into a peripheral region of the display panel.

8. The device of claim 6, wherein the source driving part outputs the data voltages having an opposite polarity with respect to a reference voltage to the adjacent source lines, respectively.

9. The device of claim 8, wherein the source driving part converts the original data signals of first and second fields into the data voltages having the opposite polarity with respect to the reference voltage and outputs the data voltages, respectively.

10. A method of driving a display apparatus including a panel having source lines and gate lines intersecting with the source lines, the method comprising:
converting original data signals transferred in an interlaced scan method into analog-type data voltages to output the data voltages to the source lines; and
selectively outputting the gate signals to odd-numbered gate lines and even-numbered gate lines corresponding to the data voltages applied to the source lines.

11. The method of claim 10, wherein the original data signals are converted into the data voltages by:
converting the original data signals into RGB signals; and
converting the RGB signals into the data voltages and outputting the data voltages.

12. The method of claim 11, wherein the data voltages having an opposite polarity with respect to a reference voltage are output to the adjacent source lines, respectively.

13. The method of claim 10, wherein the original data signals of a first field and the original data signals of a second field are converted into the data voltages to have opposite polarity with respect to a reference voltage, respectively.
